(19) United States
(12) Patent Application Publication
(10) Pub. No.: US 2025/0074272 A1
(43) Pub. Date: Mar. 6, 2025

(54) DECOUPLING MODULE

(71) Applicants: Adient US LLC, Plymouth, MI (US); Autoliv Development AB, Vårgårda (SE)

(72) Inventors: Christian WOLF, Dielkirchen (DE); Jens EHLERS, Horst (DE); Arndt SÖHNCHEN, Hamburg (DE)

(21) Appl. No.: 18/818,667

(22) Filed: Aug. 29, 2024

(30) Foreign Application Priority Data
Aug. 29, 2023 (EP) 23 193 956.2

(51) Int. Cl. B60N 2/427; B60N 2/08; B60N 2/42

(52) U.S. Cl. CPC B60N 2/42781; B60N 2/08; B60N 2/4214; B60N 2/42736; B60N 2/43

(57) ABSTRACT

A decoupling module for two releasably interconnected components may have a module housing with a first coupling interface for one of the components and with a hollow space. The module may also have a locking unit which is mounted axially movably in the module housing and, in an initial state, protrudes at least partially from the module housing to lock the two components releasably to each other. The module may also have a drive unit which on the other hand is arranged in a positionally fixed manner in the module housing. The locking unit and the drive unit are designed to interact in such a way that, upon triggering or firing of the drive unit, the locking unit can be acted upon or is acted upon abruptly and directly by a pressure surge propagating in the hollow space and moves into the module housing.

### FIELD

The invention relates to a decoupling module for two releasably interconnected components, and to a vehicle seat having such a decoupling module.

### BACKGROUND

Fastening devices for releasably fastening an element to a vehicle-mounted component are known from DE 10 2009 033 721 B4 and DE 10 2011 014 869 A1.

The problem addressed by the invention is to improve a decoupling module of the aforementioned type, which in particular also decouples under load, and to make available a corresponding vehicle seat having an improved decoupling module of this kind.

The first problem mentioned is solved, according to the invention, by a decoupling module and the second problem mentioned is solved, according to the invention, by a vehicle seat having the features of the claims described herein.

Advantageous embodiments, which can be implemented individually or in combination with one another, are the subject matter of the dependent claims.

The decoupling module according to the invention for two releasably interconnected components comprises at least a module housing with an in particular outer first coupling interface, in particular for coupling to one of the components, and a hollow space, a locking unit which on the one hand is mounted axially movably in the module housing and, in an initial state, in particular in a locking position or in a blocking position for locking a connection between the two components, protrudes at least partially from the module housing, in particular in order to lock or couple the two components releasably to each other, and a drive unit which on the other hand is arranged in a positionally fixed manner in the module housing, wherein the locking unit and the drive unit are designed interacting in such a way that, upon triggering or firing of the drive unit, the locking unit can be acted upon or is acted upon abruptly and directly by a pressure surge propagating in the hollow space and moves into the module housing. The locking unit is axially movable along a linear axis and moves linearly into the module housing. In other words: The decoupling module is designed, with the locking unit and the drive unit which interact with each other, as a linear lock release, in particular a linear bolt release or a linear bar release.

The propagating pressure surge or an integral pressure that builds up can be generated, for example, by a gas or gas mixture of the drive unit being introduced into the hollow space. The hollow space is also designated as a gas space. By virtue of the fact that the pressure surge acts directly on the locking unit, a particularly compact decoupling module with a high operating force and a high operating pressure is made possible.

In addition, module housing, locking unit and drive unit can be arranged coaxially to one another, for example. Preferably, module housing, locking unit and drive unit can be oriented and arranged coaxially to one another with respect to their longitudinal axes. In particular, the module housing has an in particular beaker-shaped hollow space in which the locking unit and the drive unit are arranged coaxially to each other. In addition, the module housing, the locking unit and the drive unit can each be arranged, for example, at least partially overlapping and coaxial to one another. The coaxial arrangement of the components of the decoupling module permits simple manufacture and a simple, modular and particularly compact design of the decoupling module.

The drive unit can be designed as a pyrotechnic device, for example. The drive unit can in particular be supported on the one hand on the module housing and on the other hand on the locking unit via its front ends. The decoupling module, in particular the module housing, for example the module cover, can additionally have a second, for example outer, coupling interface.

The first coupling interface of the module housing can be designed as an external thread, for example. The second coupling interface of the module housing can be designed, for example, as a nut, in particular a hexagon profile or a hexagon nut. In this way, the decoupling module can be easily fastened to one of the two components to be connected, without tools in the case of just one coupling interface, or using a wrench in the case of two coupling interfaces.

For example, one axial end of the drive unit can be designed as a module cover which, in an assembled state of the decoupling module, is connected to the module housing by form-fit and/or force-fit engagement. For example, the module cover can be fitted to the module housing by crimping, screwing or the like.

For example, the module housing and the drive unit can be connected to each other in such a way that, in the assembled state, they are sealed off in a gastight manner from the outside. The module housing can in particular be closed off in a gastight manner from the outside in such a way that, when the drive unit is triggered, the locking unit is held at least temporarily in the retracted position. Alternatively, the locking unit can be designed to be lockable in the retracted position.

In addition, the module cover can be arranged partially overlapping the module housing. For example, the module housing and the module cover can be fitted telescopically one inside the other. For example, the module cover can be able to be slipped at least partially over an outer wall of the module housing. Alternatively, an outer wall of the module housing can be able to be slipped partially over the module cover. Such a design permits a variable adjustment of the modular housing of the decoupling module and thus different module sizes and module dimensions.

The locking unit can, for example, comprise a locking portion and a pressure effect portion which, upon triggering or firing of the drive unit, can be acted upon by the pressure surge, such that the locking unit moves under acceleration into the module housing and decouples the two components from each other. The site where force acts on the locking unit can be designed variably in particular in relation to the geometric design, orientation and arrangement of the locking unit relative to the drive unit and can be influenced by these parameters.

The pressure effect portion can be designed, for example, as a cylindrical hollow chamber or beaker-shaped hollow chamber with at least one recess or with at least one gas channel. The at least one recess or the at least one gas channel can be designed, for example, as a gas passage, a through-flow opening, an overflow opening, and overflow channel or the like. For example, the pressure effect portion can comprise a plurality of recesses or a plurality of gas channels that are symmetrically distributed, in particular symmetrically distributed on the pressure effect portion.

The at least one recess or the at least one gas channel extends along an axial longitudinal direction and a transverse direction running perpendicular to the axial longitudinal direction. For example, the extent in the axial longitudinal direction is greater than the extent in the transverse direction. In this way, when the drive unit is triggered, a propagating pressure surge of the gas introduced into the hollow space is optimized. In particular, pressure is able to act over a large surface area.

The locking portion can be designed, for example, as a shaft end, a bar, a pin or another suitable locking element. In a connected state of the two components, the locking unit, in particular the locking element, can be mounted in a pretensioned manner by means of a force store, in particular a spring element, in particular a pretensioning spring, for the locking connection of the two components. The pretensioning spring is designed in particular to pretension the locking unit in the initial state, in particular in a locked state (also called locking position) or a blocking state (also called blocking position). In particular, the force store and the sealing rings are configured in such a way that, in particular, the sealing force of the sealing rings is greater than the pretensioning force of the force store. In this way, the decoupling module is sufficiently sealed with respect to the pressure surge upon triggering of the drive unit and at the same time is locked sufficiently securely in the initial state, so that the locking unit is held in its position, in particular in its blocking position or locking position.

The force store can bear or support itself on the one hand on the pressure effect portion and on the other hand on a module cover, on the module housing or directly on the drive unit, which is connected in a positionally fixed manner to the module housing.

The module housing can additionally have, for example in a housing base for a shaft end of the locking unit, an opening through which the shaft end, in the connected state, protrudes at least in part from the module housing in order to connect or hold the two components to each other by locking.

The vehicle seat according to the invention comprises the above-described decoupling module.

### SUMMARY

In summary and in other words, an axially symmetrical decoupling module is made available by the invention. The axially symmetrical decoupling module has, on the one hand, the first coupling interface of the module housing designed as a screw thread and with an opening for the locking unit, designed as a pin or a shaft end, and, on the other hand, the second coupling interface, designed for example as a hexagon or nut.

By means of such a decoupling module having at least one of the coupling interfaces, said decoupling module can be easily screwed onto one of the components.

### DESCRIPTION OF THE FIGURES

The invention is explained in more detail below on the basis of advantageous exemplary embodiments shown in the figures. However, the invention is not limited to these exemplary embodiments.

FIG. 1 shows a schematic view of a vehicle seat having a longitudinal adjustment device,

FIG. 2 shows an exploded view of a decoupling module according to the invention, in a first exemplary embodiment,

FIG. 3 shows a perspective view of the decoupling module of the first exemplary embodiment in the assembled state,

FIG. 4 shows a perspective view of the decoupling module of the first exemplary embodiment in the assembled state,

FIG. 5 shows a perspective view of a module cover with a pre-fitted drive unit,

FIG. 6 shows a perspective view of a locking unit of the decoupling module of the first exemplary embodiment,

FIG. 7 shows an exploded view of a decoupling module according to the invention, in a second exemplary embodiment,

FIG. 8 shows an exploded view of a decoupling module according to the invention, in a third exemplary embodiment,

FIG. 9 shows a perspective view of the decoupling module according to FIG. 8 in the assembled state,

FIG. 10 shows a schematic perspective view of a multi-part locking unit in the assembled state,

FIG. 11 shows a schematic sectional view of the decoupling module according to FIG. 9 prior to or upon triggering of a drive unit,

FIG. 12 shows a schematic sectional view of the decoupling module according to FIG. 9 after the drive unit is triggered, and

FIG. 13 shows a schematic perspective view of the decoupling module in the assembled state, with a crimped module housing instead of a screwed module housing.

### DETAILED DESCRIPTION

Parts corresponding to one another are provided with the same reference signs in all of the figures.

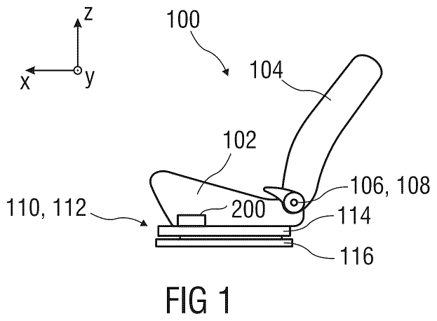

A vehicle seat 100 shown schematically in FIG. 1 will be described below on the basis of three mutually perpendicular spatial directions. In the case of a vehicle seat 100 installed in the vehicle, a longitudinal direction x runs substantially horizontally and preferably parallel to a vehicle longitudinal direction, which corresponds to the normal direction of travel of the vehicle. A transverse direction y, running perpendicular to the longitudinal direction x, is likewise oriented horizontally in the vehicle and runs parallel to a vehicle transverse direction. A vertical direction z runs perpendicular to the longitudinal direction x and perpendicular to the transverse direction y. In the case of a vehicle seat 100 installed in the vehicle, the vertical direction z runs preferably parallel to a vehicle vertical axis.

The position terminology and direction terminology used, such as front, rear, top and bottom, relate to a viewing direction of an occupant seated in a normal sitting position on the vehicle seat 100, with the vehicle seat 100 having been installed in the vehicle in a usage position suitable for conveying passengers, with an upright backrest 104, and being oriented in a direction of travel in the conventional manner. However, the vehicle seat 100 can also be installed in or moved into some other orientation, for example transverse to the direction of travel. Unless described differently, the vehicle seat 100 is constructed to be mirror-symmetrical to a plane running perpendicular to the transverse direction y.

The backrest 104 can be arranged pivotably on a seat part 102 of the vehicle seat 100. For this purpose, the vehicle seat 100 can optionally comprise a fitting 106, in particular an adjustment fitting, rotary fitting, latching fitting or tumble fitting.

The position terminology and direction terminology used, such as radially, axially and circumferentially, relate to an axis of rotation 108 of the fitting 106. Radially means perpendicular to the axis of rotation 108. Axially means in the direction of or parallel to the axis of rotation 108.

The vehicle seat 100 can optionally comprise a longitudinal adjustment device 110. The longitudinal adjustment device 110 comprises, for example, a rail arrangement 112 with a first rail element 114 and a second rail element 116. The first rail element 114 is adjustable in a longitudinal direction x relative to the second rail element 116. The first rail element 114 is fastened to the seat part 102. The second rail element 116 is fastened to a structural element of a vehicle, for example to a vehicle floor.

For better clarity, the first rail element 14 is referred to in the description below as the top rail 114. This top rail 114 (also called running rail or slide) is assigned to the vehicle seat 100 and configured to carry said vehicle seat 100. The second rail element 116 is referred to below as the bottom rail 116. The bottom rail 116 is connected fixedly and, for example, to the floor of a vehicle.

A decoupling module 200 can be provided in order to permit instant decoupling, for example of components of the vehicle seat 100, in particular of components of the longitudinal adjustment device 110, in the event of a collision.

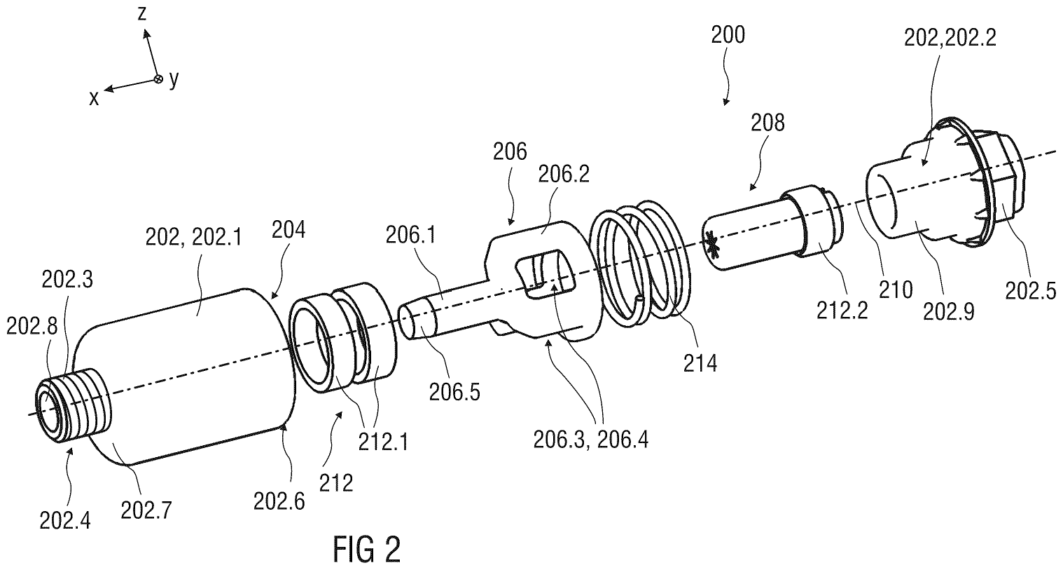

FIG. 2 shows an exploded view of a decoupling module 200 according to the invention, in a first exemplary embodiment.

The decoupling module 200 comprises at least one module housing 202. The module housing 202 is designed as a hollow body. The module housing 202 has a hollow space 204. The hollow space 204 has in particular a hollow cylindrical shape or beaker shape. The module housing 202 can be of modular design. The module housing 202 can comprise a module main body 202.1 and a module cover 202.2. The module housing 202 additionally comprises a first coupling interface 202.3.

The first coupling interface 202.3 is designed as an outer interface for coupling to one of the two components which are releasably lockable or locked to each other by means of the decoupling module 200. The first coupling interface 202.3 is designed as an external thread, for example. The first coupling interface 202.3 is designed, for example, as an external thread on the outside of a first front end 202.4. The decoupling module 200 can thus be easily screwed into or onto one of the two components.

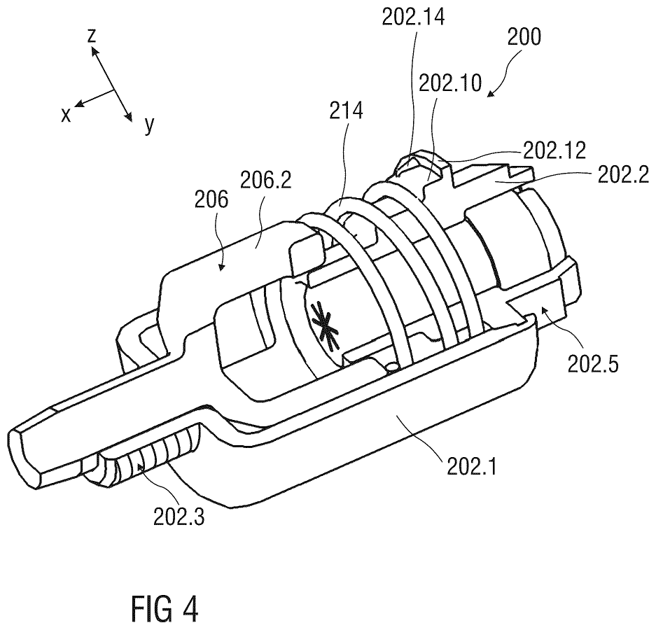

The decoupling module 200 additionally comprises a locking unit 206 and a drive unit 208. The locking unit 206 is on the one hand mounted axially movably in the module housing 202. In an initial state, the locking unit 206 protrudes at least partially from the module housing 202, in particular in order to lock or couple the two components releasably to each other, as is shown in FIG. 4.

The drive unit 208 is on the other hand arranged in a positionally fixed manner in the module housing 202.

The locking unit 206 and the drive unit 208 are designed interacting with each other in such a way that, upon triggering or firing of the drive unit 208, the locking unit 206 can be acted upon or is acted upon abruptly and directly by a pressure surge propagating or building up in the hollow space 204 and moves into the module housing 202.

The locking unit 206 is axially movable along a linear axis 210 and, upon triggering of the drive unit 208, moves linearly into the module housing 202. In other words: the decoupling module 200 is designed, with the locking unit 206 and the drive unit 208 which interact with each other, as a linear lock release, in particular a linear bolt release or a linear bar release.

The drive unit 208 can be designed, for example, as a pyrotechnic device, for example a gas generator with a pyrotechnic detonator. The drive unit 208 can in particular be supported via its front ends on the one hand on the module housing 202, in particular on the module cover 202.2, and on the other hand on the locking unit 206.

The module housing 202 can additionally be designed with a second coupling interface 202.5. For example, the second coupling interface 202.5 is an outer interface, for example an interface designed as a nut or hexagon.

The module cover 202.2 can be arranged, for example, on a second front end 202.6 of the module main body 202.1 opposite the first front end 202.4 and, in an assembled state of the decoupling module 200, can be connected to the module main body 202.1 by form-fit and/or force-fit engagement. For example, the module cover 202.2 can be fitted onto the module main body 202.1 by crimping, screwing or the like.

The module cover 202.2 can have a receptacle 202.9 for the drive unit 208, said receptacle 202.9 extending in the direction of the module main body 202.1.

In addition, the module housing 202 and the drive unit 208 can be connected to each other in such a way that, in the assembled state, they are sealed off in a gastight manner from the outside. For example, at least one seal 212 can be provided. The seal 212 comprises, for example, two first sealing rings 212.1, which are arranged between the locking unit 206 and the module housing 202. For example, the seal 212 can be designed additionally or alternatively as a second sealing ring 212.2, which is arranged on the outside of the drive unit 208 and closes off the module cover 202.2 from the outside. The module housing 202 can in particular be closed off in a gastight manner from the outside by means of the sealing rings 212.1, 212.2 in such a way that, when the drive unit 208 is triggered, the locking unit 206 is held at least temporarily in the retracted position. Alternatively, the locking unit 206 can be designed to be lockable in the retracted position.

The locking unit 206 can, for example, comprise a locking portion 206.1 and a pressure effect portion 206.2 which, upon triggering or firing of the drive unit 208, can be acted upon by the pressure surge, such that the locking unit 206 moves under acceleration into the module housing 202 and decouples the two components from each other. The site where force acts on the locking unit 206, in particular on the pressure effect portion 206.2, can be designed variably in particular in relation to the geometric design, orientation and arrangement of the locking unit 206 relative to the drive unit 208 and can be influenced by these parameters.

The pressure effect portion 206.2 can be designed, for example, as a cylindrical hollow chamber or beaker-shaped hollow chamber with at least one recess 206.3. The at least one recess 206.3 can be designed, for example, as a gas passage 206.4. Alternatively, the recess 206.3 can be designed as a through-flow opening, an overflow opening or the like. For example, the pressure effect portion 206.2 can comprise a plurality of recesses 206.3 that are symmetrically distributed.

The locking portion 206.1 can be designed, for example, as a shaft end 206.5. Alternatively, the locking portion 206.1 can be designed as a bar, a pin or another suitable locking element. In a connected state of the two components, and thus in the initial state, the locking portion 206.1 can be mounted in a pretensioned manner by means of a force store 214, in particular a spring element, in particular a helical spring or pretensioning spring, for the locking connection of the two components.

The module housing 202 can additionally have, for example in a housing base 202.7 for a shaft end 206.5 of the locking unit 206, in particular for a bolt-shaped or pin-shaped shaft end 206.5, an opening 202.8 through which the shaft end 206.5, in the connected state, protrudes at least in part from the module housing 202 in order to connect or hold the two components to each other by locking.

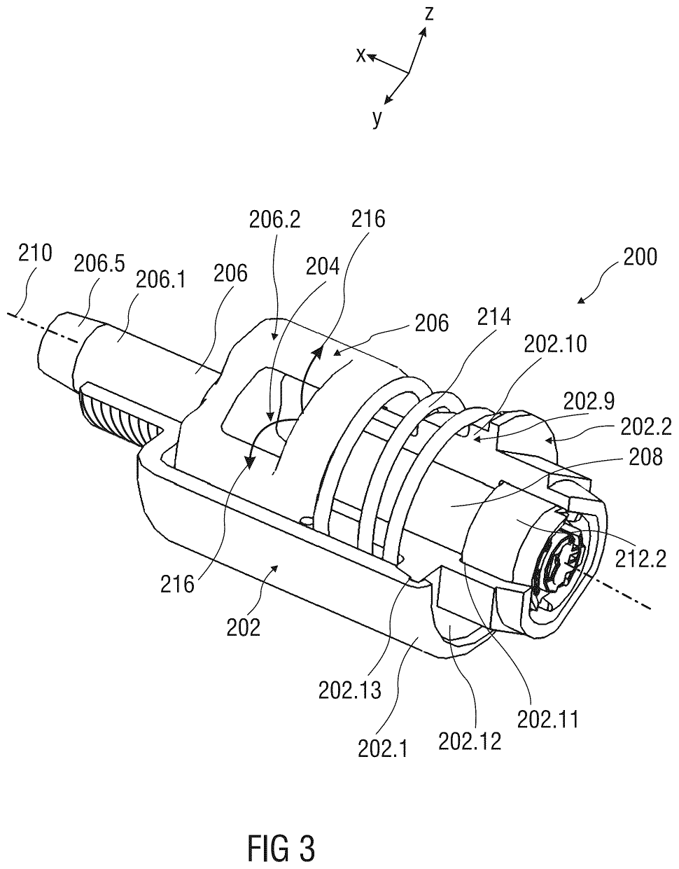

FIG. 3 shows a perspective and partially sectional view of the decoupling module 200 of the first exemplary embodiment in the assembled state.

The module cover 202.2 can be arranged partially overlapping the module main body 202.1. For example, the module main body 202.1 and the module cover 202.2 can be fitted telescopically one inside the other. For example, an outer wall of the module main body 202.1 can be able to be slipped partially over the module cover 202.2.

The receptacle 202.9 of the module cover 202.2 is designed on the inside to correspond to an outer shape and/or outer dimensions of the drive unit 208. On the outside, the receptacle 202.9 is designed in such a way that the force store 214 can support itself thereon. For example, the receptacle 202.9 has at least one shoulder 202.10 on the outside. On the inside, the receptacle 202.9 can have a groove 202.11 for the second sealing ring 212.2. In addition, the module cover 202.2 can have a fastening flange 202.12 which is arranged with form-fit and/or force-fit engagement in a fastening groove 202.13 of the module main body 202.1.

Upon firing of the drive unit 208, the latter generates a pressure surge or an integral pressure by a gas 216 or gas mixture introduced into the hollow space 204. The hollow space 204 is also designated as a gas space. The gas 216 acts on the pressure effect portion 206.2 of the locking unit 206. The fact that the pressure surge acts directly on the locking unit 206 permits a particularly compact decoupling module 200 with a high operating force and with a high operating pressure.

On account of the pressure surge acting on it, the locking unit 206 moves linearly into the module housing 202, forming a linear bolt release or a linear bar release.

To achieve a compact design, the module housing 202, the locking unit 206 and the drive unit 208 can be arranged coaxially to one another. Preferably, module housing 202, locking unit 206 and drive unit 208 can be oriented and arranged coaxially to one another with respect to their longitudinal axes and the linear axis 210.

In addition, the module housing 202, the locking unit 206 and the drive unit 208 can each be arranged, for example, at least partially overlapping and coaxial to one another.

FIG. 4 shows a perspective view of the decoupling module 200 of the first exemplary embodiment in the assembled state.

The force store 214 is supported on the one hand on the shoulder 202.10 of the module cover 202.2 and on the other hand on a front end of the pressure effect portion 206.2 of the locking unit 206.

The fastening flange 202.12 of the module cover 202.2 can additionally be provided with an anti-rotation means 202.14. The anti-rotation means 202.14 can be formed, for example, by at least one radially protruding rib and a corresponding slot on an inner side of the module main body 202.1. In the mounted state, the rib engages in a manner fixed in rotation in the slot. This can assist the screwing of the decoupling module 200 into one of the components, in particular an internal thread, via the first coupling interface 202.3, in particular an external thread, by means of a tool that engages on the second coupling interface 202.5, in particular a hexagon or a nut element.

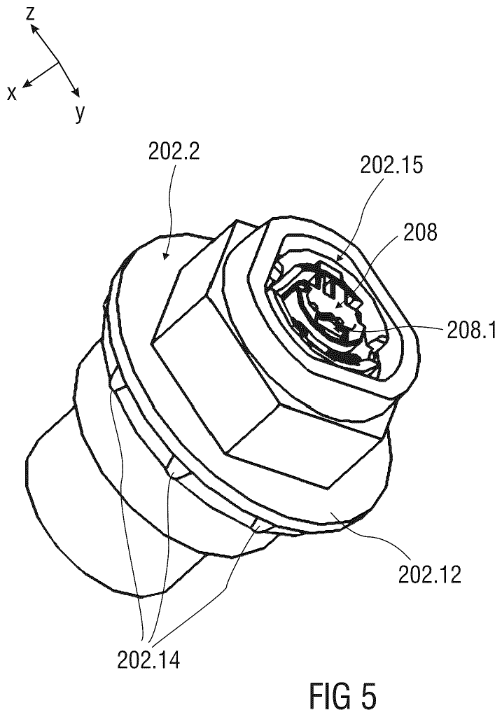

FIG. 5 shows a perspective view of the module cover 202.2 with the drive unit 208, which are pre-fitted together.

At its front end, the module cover 202.2 has an attachment opening 202.15 for the drive unit 208. An attachment unit 208.1 for the attachment of electrical lines and/or firing lines protrudes into the attachment opening 202.15. The attachment unit 208.1 is arranged in the attachment opening 202.15 freely accessible from the outside.

The anti-rotation means 202.14 can have a plurality of ribs, which are arranged symmetrically below the fastening flange 202.12.

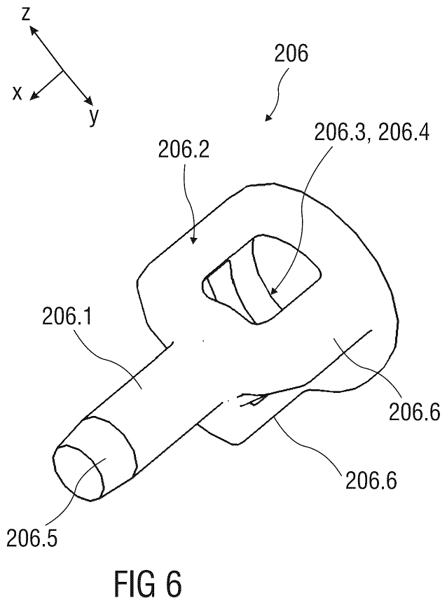

FIG. 6 shows a perspective view of the locking unit 206.

The locking unit 206 has the locking portion 206.1, with the shaft end 206.5 that lockingly connects the two components to each other (not shown), and the pressure effect portion 206.2 with the recesses 206.3 which are designed as a gas passage 206.4.

The pressure effect portion 206.2 has a beaker-shaped design and comprises a number of alternately arranged separating webs 206.6 and recesses 206.3.

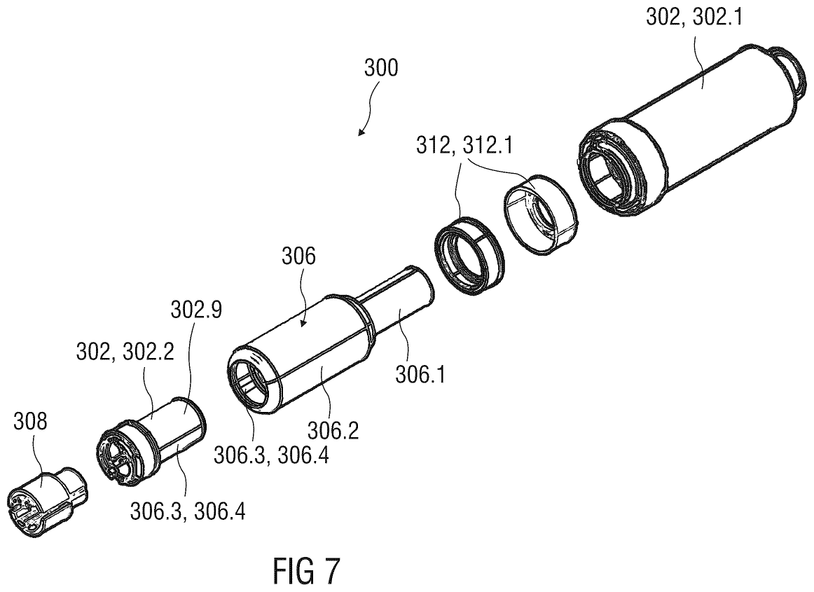

FIG. 7 shows an exploded view of a decoupling module 300 according to the invention, in a second exemplary embodiment.

The decoupling module 300 differs from the decoupling module 200 only in the form of the locking unit 306 and of the module housing 302. All of the other structural features and functions of the decoupling module 300 are analogous to the decoupling module 200 described above.

Instead of the decoupling module 200 having recesses 206.3 designed as gas passages 206.4, the decoupling module 300 has gas channels 306.4 as recesses 306.3. The gas channels 306.4 can be arranged, for example, on an outer side of the inwardly protruding receptacle 302.9 of the module housing 302. Alternatively or additionally, gas channels 306.4 can be formed on an inner side of the hollow cylindrical pressure effect portion 306.2 of the locking unit 306.

From the pressure effect portion 306.2, the locking portion 306.1 protrudes in the direction of the module main body 302.1.

The decoupling module 300 is closed off in a gastight manner from the outside by means of the seal 312 designed as sealing rings 312.1.

The drive unit 308 is arranged and held analogously in the module cover 302.2 in a positionally fixed manner, in particular by form-fit and/or force-fit engagement.

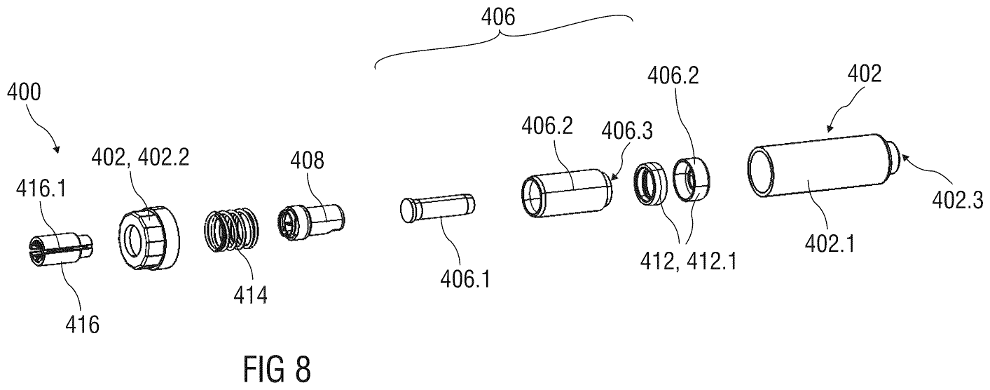

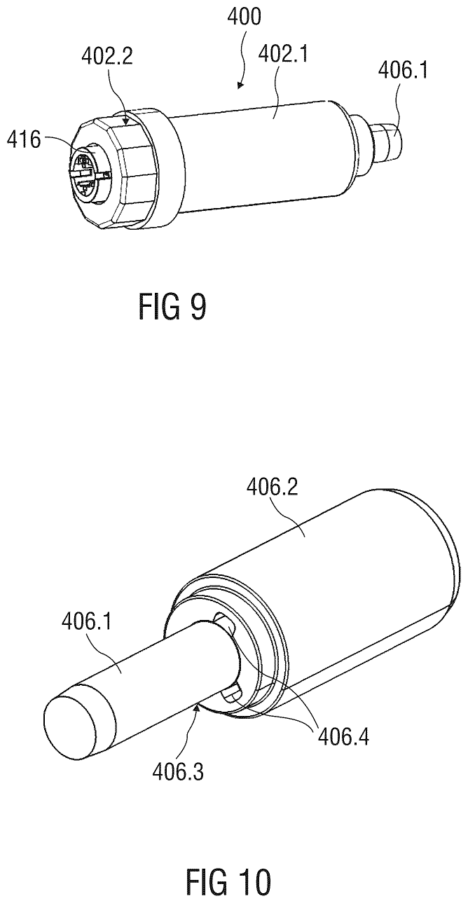

FIG. 8 shows an exploded view of a decoupling module according to the invention in a third exemplary embodiment, and FIG. 9 shows the decoupling module 400 according to FIG. 8 in the assembled state.

The decoupling module 400 differs from the decoupling module 200 or 300 only in the structure of the locking unit 306. All of the other structural features and functions of the decoupling module 400 are analogous to the decoupling module 200 or 300 described above.

The locking unit 406 of the decoupling module 400 has a multi-part design. The locking unit 406 comprises a separate locking portion 406.1, which is designed as a separate pin. The pressure effect portion 406.2 is likewise designed separately. The pressure effect portion 406.2 is designed as an inner hollow cylinder or inner cylindrical housing.

The pin-shaped locking portion 406.1 can be fitted into the pressure effect portion 406.2. The locking portion 406.1 is of such a shape and/or of such dimensions that, when fitted in the pressure effect portion 406.2, it protrudes through an opening 406.3 and in the direction of the module main body 402.1 of the module housing 402 and extends through a housing opening 402.3 flush with the opening 406.3 and protrudes outward from the module main body 402.1.

The module main body 402.1 is a hollow cylinder and forms an outer portion of the module housing 402. The module main body 402.1 can be closed by the module cover 402.2 on the side opposite the housing opening 402.3. Two seals 412 designed as sealing rings 412.1 are provided to seal off the module housing 402. By means of the seal 412 designed as sealing rings 412.1, the decoupling module 400 is closed off from the outside in a gastight manner.

The drive unit 408 is arranged and held analogously in the module cover 402.2 in a positionally fixed manner, in particular by form-fit and/or force-fit engagement.

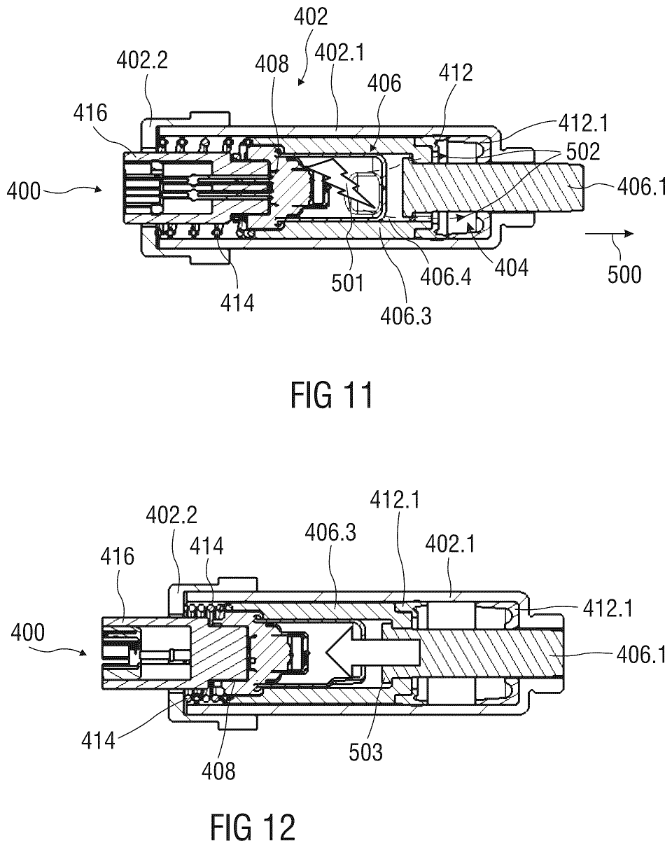

In a connected state of the two components, the locking portion 406.1 can be mounted in a pretensioned manner in the module main body 402.1 by means of a force store 414, in particular a spring element, in particular a helical spring, for the locking connection of the two components, as is shown in FIGS. 11 and 12.

In addition, the decoupling module 400 can for example comprise an elongate attachment element 416. The attachment element 416 is designed as an interface or adapter, for the attachment of lines or cables to the drive unit 408. The attachment element 416 is a cylindrical element, in particular made of a flexible material. The attachment element 416 (also called an elongate shunt ring) has a longitudinal gap 416.1. The longitudinal gap 416.1 serves in particular for compensation of tolerances.

FIG. 9 shows a perspective view of the decoupling module 400 according 5 to FIG. 8 in the assembled state with the outer module cover 402.2 and, protruding from the latter, the attachment element 416, and with the outer module main body 402.1 and, protruding from the latter, the pin-shaped locking portion 406.1 of the locking unit 406.

FIG. 10 shows a schematic perspective view of the multi-part locking unit 406 in the assembled state. The multi-part locking unit 406 comprises the pin-shaped locking portion 406.1 and the cylindrical pressure effect portion 406.2. Instead of the recesses 206.3 provided in the decoupling module 200 according to FIG. 2 and designed as gas passages 206.4, the pressure effect portion 406.2 comprises, as recesses, gas channels 406.4 analogous to the gas channels 306.4 of the decoupling module 300 according to FIG. 7. The gas channels 406.4 can be formed, for example, on an inner side of the hollow cylindrical pressure effect portion 406.2 of the locking unit 406. FIG. 11 shows a schematic sectional view of the decoupling module 400 according to FIG. 9 prior to or upon triggering of the drive unit 408. The force store 414 is in the relaxed state or partially relaxed state and holds or presses the locking unit 406 in the locking direction 500 against the seal 412 in the module housing 402.

Upon triggering 501 of the drive unit 408, a pressure surge against the locking portion 406.1 is generated by a gas or gas mixture introduced according to arrows 502 through the gas channels 406.4 into the hollow space 404, in particular into the hollow space 404 sealed off from the outside by means of the sealing rings 412.1. In the direction of the hollow space 404, the pressure effect portion 406.2 is provided with the gas channels 406.4, which are shown in FIG. 10.

By virtue of the fact that the pressure surge acts directly on the locking unit 406, the pressure effect portion 406.2 is moved, together with the fixedly connected locking portion 406.1, into the decoupling module 400 in the unlocking direction 503, as is shown in FIG. 12.

FIG. 12 shows a schematic sectional view of the decoupling module 400 5 according to FIGS. 9 and 10 after triggering of the drive unit 408 and in the unlocked state.

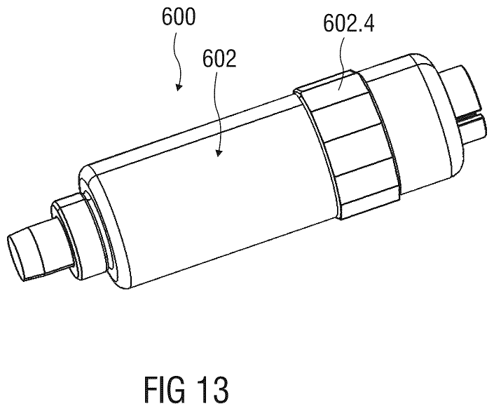

FIG. 13 shows a schematic perspective view of a further decoupling module 600 in the assembled state with a crimped module housing 602. All of the above-described screwed module housings 202, 302 and 402 can, instead of the respective module cover 202.2, 302.2 and 402.2, which is screwable or screwed onto the associated module main body 202.1, 302.1 and 4021, have a crimped or crimpable module housing 202, 302 and 402. For this purpose, the respective module housing 202, 302 and 402 can be designed analogously to the module housing 602 according to FIG. 13.

The module housing 602 is configured in such a way that it is plastically deformed by means of a crimp band 602.4, in particular squeezed, flanged or folded, and is closeable from the outside in a sealed manner.

### LIST OF REFERENCE SIGNS

100 vehicle seat
102 seat part
104 backrest
106 fitting
108 axis of rotation
110 longitudinal adjustment device
112 rail arrangement
114 first rail element (top rail)
116 second rail element (bottom rail)
200 decoupling module
202 module housing
202.1 module main body
202.2 module cover
202.3 first coupling interface
202.4 first front end
202.5 second coupling interface
202.6 second front end
202.7 housing base
202.8 opening
202.9 receptacle
202.10 shoulder
202.11 groove
202.12 fastening flange
202.13 fastening groove
202.14 anti-rotation means
202.15 attachment opening
204 hollow space
206 locking unit
206.1 locking portion
206.2 pressure effect portion
206.3 recess
206.4 gas passage
206.5 shaft end
206.6 separating web
208 drive unit
208.1 attachment unit
210 linear axis
212 seal
212.1 first sealing ring
212.2 second sealing ring
214 force store
216 gas
300 decoupling module
302 module housing
302.1 module main body
302.2 module cover
302.9 receptacle
306 locking unit
306.1 locking portion
306.2 pressure effect portion
306.3 recess
306.4 gas channel
308 drive unit
312 seal
312.1 sealing ring
400 decoupling module
402 module housing
402.1 module main body
402.2 module cover
402.3 housing opening
404 hollow space
406 locking unit
406.1 locking portion
406.2 pressure effect portion
406.3 opening
406.4 gas channel
408 drive unit
412 seal
412.1 sealing rings
414 force store
416 attachment element
416.1 longitudinal gap
500 locking direction
501 triggering
502 arrow
503 unlocking direction
600 decoupling module
602 module housing
602.4 crimp band
x longitudinal direction
y transverse direction
z vertical direction

What is claimed is:

1. A decoupling module for two releasably interconnected components, comprising:
a module housing with a first coupling interface for one of the components and with a hollow space,
a locking unit which on the one hand is mounted axially movably in the module housing and, in an initial state, protrudes at least partially from the module housing in order to lock the two components releasably to each other, and
a drive unit which on the other hand is arranged in a positionally fixed manner in the module housing,
wherein the locking unit and the drive unit are designed interacting in such a way that, upon triggering or firing of the drive unit, the locking unit can be acted upon or is acted upon abruptly and directly by a pressure surge propagating in the hollow space and moves into the module housing.

2. The decoupling module as claimed in claim 1, wherein the module housing, the drive unit and the locking unit are arranged coaxially to one another.

3. The decoupling module as claimed in claim 1, wherein the first coupling interface is designed as an external thread.

4. The decoupling module as claimed in claim 1, wherein a module cover is provided which, in an assembled state of the decoupling module, is connected to the module housing by form-fit and/or force-fit engagement.

5. The decoupling module as claimed in claim 1, wherein the locking unit comprises a locking portion and a pressure effect portion which, upon triggering or firing of the drive unit, can be acted upon by the pressure surge, such that the locking unit is moved under acceleration into the module housing and such that the locking unit decouples the two components from each other.

6. The decoupling module as claimed in claim 5, wherein the pressure effect portion is designed as a cylindrical hollow chamber or beaker-shaped hollow chamber with at least one recess or with at least one gas channel.

7. The decoupling module as claimed in claim 6, wherein the at least one recess or the at least one gas channel extends along an axial longitudinal direction and a transverse direction running perpendicular to the axial longitudinal direction, wherein the extent in the axial longitudinal direction is greater than the extent in the transverse direction.

8. The decoupling module as claimed in claim 6, wherein a plurality of recesses or a plurality of gas channels are distributed symmetrically on the pressure effect portion.

9. The decoupling module as claimed in claim 5, wherein the locking portion is designed as a shaft end, a bar, a pin or another suitable locking element.

10. The decoupling module as claimed in claim 1, wherein the locking unit, in a connected state of the two components, is mounted in a pretensioned manner by a force store for the locking connection of the two components.

11. The decoupling module as claimed in claim 10, wherein the force store bears or is supported, on the one hand, on the pressure effect portion and, on the other hand, on a module cover or the module housing.

12. The decoupling module as claimed in claim 10, wherein the force store (214) is designed as a pretensioning spring, which pretensions the locking unit in the initial state.

13. The decoupling module as claimed in claim 1, wherein the module housing has, in a housing base for a shaft end of the locking unit, an opening through which the shaft end, in the connected state, protrudes at least in part from the module housing in order to connect the two components to each other by locking.

14. The decoupling module as claimed in claim 1, wherein the decoupling module is designed axially symmetrically in the axial longitudinal direction.

15. A vehicle seat having a decoupling module as claimed in claim 1.
